(19) United States
(12) Patent Application Publication
(10) Pub. No.: US 2026/0341996 A1
(43) Pub. Date: Oct. 29, 2026

(54) CONTACT TERMINAL

(71) Applicant: SHAO-PEI KUO, TAIPEI (TW)

(72) Inventor: SHENG-HSIEN KUO, TAIPEI (TW)

(21) Appl. No.: 19/189,619

(22) Filed: Apr. 25, 2025

(51) Int. Cl. H01R 13/42

(52) U.S. Cl. CPC H01R 13/42

(57) ABSTRACT

The present invention provides a contact terminal including a core sheet and a computer or telephone line connector. The computer or telephone line connector has a connector structure, and the connector structure is provided with a plurality of core sheet slots. When the core sheet is inserted into the core sheet slots, two disconnected parts of the core sheet respectively abut against two side walls of the core sheet slot.

### FIELD OF THE INVENTION

The present invention is related to a contact terminal, and more particularly to a computer or telephone line contact terminal.

### BACKGROUND OF THE INVENTION

In the prior art, a core sheet in a contact terminal of a telephone or a computer is mainly made of a metallic copper sheet. When the copper sheet is stamped, it is a core sheet body in a strip shape which is made of a plurality of core sheets connected. In order to prevent the copper core sheet from oxidizing, the core sheet body is subsequently plated with an alloy protective layer to prevent the core sheet from being oxidized and affecting subsequent signal transmission and causing a short circuit, thereby affecting the normal transmission of the signal. However, each of the core sheets in the core sheet body must be cut one by one before an individual core sheet is inserted into the contact terminal of the telephone or the computer. In this way, after the individual core sheets are cut, the disconnected parts connecting two side walls of the individual core sheets will form a bare copper state due to the cutting process. Also, when the disconnected parts are inserted into the contact terminal of the telephone or the computer, the disconnected parts will be exposed to the outside of core sheet slots due to the overall design of the core sheet in the prior art and the internal structure design of the conventional contact terminals. Thus, based on no alloy electroplating protective layer, this will cause the disconnected parts to oxidize due to long-term exposure to the air or due to a humid environment, thereby affecting the normal transmission of signals.

Therefore, in the industry, there is an urgent need of a computer or telephone line contact terminal that can avoid the above-mentioned problem. Or, the industry is in urgent need of developing a solution to improve the core sheet or the internal structure of the conventional contact terminal design to meet the contact terminal and core sheet related regulatory specifications while avoiding the oxidation problem of the disconnection parts.

### SUMMARY OF THE INVENTION

In view of the foregoing problems, the object of the present invention is to provide a contact terminal of a telephone or a computer, which can improve the problem of the contact terminal of the telephone or the computer in the prior art that a signal cannot be transmitted normally due to the oxidation of the internal core sheet.

In order to achieve the above-mentioned objects and effects, the present invention is to provide a contact terminal, comprising: a core sheet and a computer or telephone line connector having a connector structure which has a plurality of core sheet slots, wherein the core sheet is inserted into the core sheet slots, and two disconnected parts of the core sheet respectively slip along with two side walls of the core sheet slots and abut against the two side walls; the heights of the two side walls are greater than the heights of the disconnected parts; and the two disconnected parts are completely inserted into the core sheet slots.

In one or more embodiments of the present invention, the core sheet has a top part, a neck part and a bottom part, wherein the neck part is respectively connected to the top part and the bottom part; the top part has two corresponding protrusions near the neck part; and the two protrusions respectively protrude outwards to form the disconnected parts.

In further one or more embodiments of the present invention, the two side walls have a height difference and are not uniform planes, and the height of the side wall near to the front end of the contact terminal is less than the height of another side wall.

In further one or more embodiments of the present invention, the heights of the two side walls are greater than the heights of the disconnected parts.

In one or more embodiments of the present invention, the contact terminal is a telephone line contact terminal or a network cable contact terminal, and the side wall near the front end of the contact terminal forms an acute angle structure at the openings of the core sheet slots.

In one or more embodiments of the present invention, the bottom part is a conductive laminate.

In one or more embodiments of the present invention, the bottom part has two tip parts which are inserted into a wire hole module of the computer or telephone line connector and into an electric wire located in the wire hole module.

In one or more embodiments of the present invention, the core sheet is inserted into the core sheet slots, and the openings of the core sheet slots are higher than the top part.

Additionally, the present invention is also to provide a contact terminal, comprising: a core sheet and a computer or telephone line connector comprising a connector structure wherein the connector structure is provided with a plurality of core sheet slots, wherein the core sheet is inserted into the core sheet slots, and two corresponding side walls of the core sheet slots respectively abut against two corresponding disconnected parts of the core sheet; and wherein the height of the side wall near the front end of the contact terminal is less than the height of another side wall.

In one embodiment of the present invention, the connector structure is an insulating plastic layer.

### BRIEF DESCRIPTION OF THE DRAWINGS

FIG. 1 is a schematic view of a contact terminal according to an embodiment of the present invention;

FIG. 2 is a schematic view of a contact terminal according to another embodiment of the present invention;

FIG. 3 is a schematic view of a contact terminal according to a comparative embodiment;

FIG. 4 is a schematic view of a contact terminal according to a comparative embodiment;

FIG. 5 is a schematic view of a contact terminal according to a comparative embodiment;

FIG. 6 is a schematic view of a contact terminal according to a comparative embodiment;

FIG. 7 is a schematic view of a contact terminal according to another embodiment of the present invention; and

FIG. 8 is a schematic view of a contact terminal according to another embodiment of the present invention.

### DETAILED DESCRIPTION OF THE PREFERRED EMBODIMENTS

In order to make those skilled in the technical field of the present invention understand the content of the present invention easily, embodiments of the present invention will now be described, by way of example only, with reference to the accompanying drawings.

“One embodiment” described in the description means that a specific feature, structure, or characteristic is included in at least one of the embodiments. Thus, “one embodiment” set forth in the description does not necessarily refer to the same embodiment. In addition, a specific feature, structure, or characteristic may be implemented in any manner in one or more embodiments.

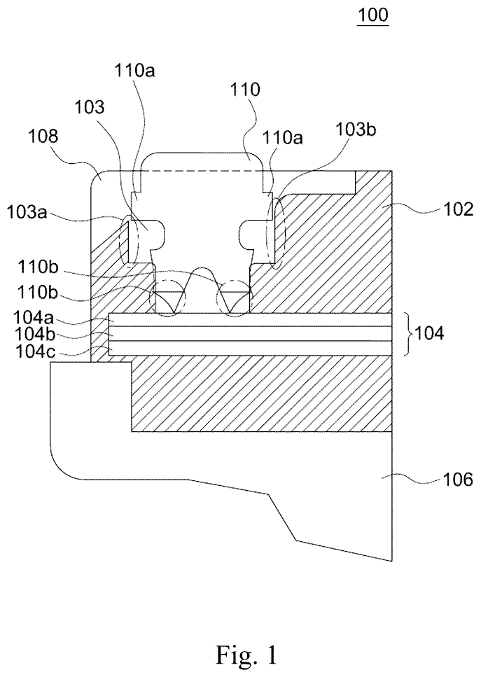

First of all, FIG. 1 is a schematic view of a contact terminal according to an embodiment of the present invention. As shown in FIG. 1, a contact terminal 100 comprise a core sheet 110 and a computer or telephone line connector. The computer or telephone line connector is composed of elements of a connector structure 102, a wire hole module 104, a pressing part 106, and a protective part 108. The connector structure 102 is an insulating plastic layer and is provided with a plurality of core sheet slots 103. The core sheet 110 is inserted into the core sheet slot 103, and the core sheet slot 103 has two corresponding side walls (103a, 103b). When the core sheet 110 is inserted, two disconnected parts 110a of the core sheet 110 can abut against them, respectively, wherein the height of the side wall 103a is less than the height of the side wall 103b, and the heights of the two side walls (103a, 103b) are greater than the heights of the disconnected parts 110a. The wire hole module 104 comprises wire holes (104a, 104b, 104c). It should be noted that in the insulating plastic layer as the connector structure 102, the side wall 103a in the core sheet slot 103 forms an acute angle structure at the openings of the core sheet slot 103. It facilitates the subsequent smooth insertion of the contact terminal 100 into a contact terminal seat (not shown). Additionally, the bottom part of the core sheet 110 has the bottom part of the core sheet 110 has two tip parts 110b.

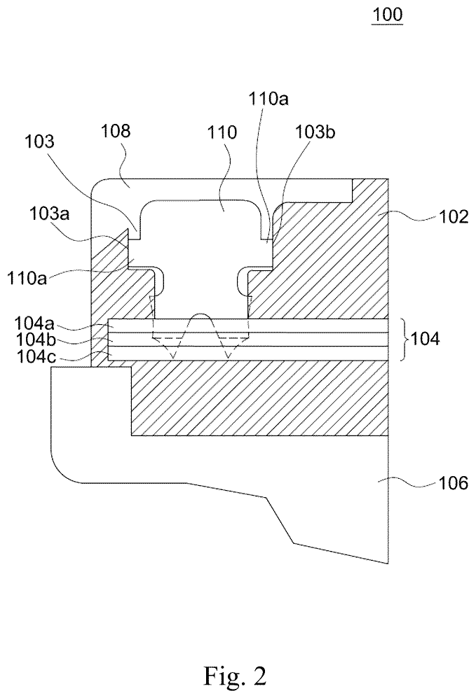

Next, another embodiment of the present invention is described with reference to FIG. 2. FIG. 2 is a schematic view of a contact terminal according to another embodiment of the present invention. As shown in FIG. 2, when the core sheet 110 is inserted into the core sheet slot 103 to a predetermined position, two corresponding side walls (103a, 103b) in the core sheet slot 103 abut against the two disconnected parts 110a of t the core sheet 110. In detail, the two side walls (103a, 103b) in the core sheet slot 103 respectively abut against the two disconnected parts 110a of t the core sheet 110. Since the heights of the two side walls (103a, 103b) of the core sheet slot are higher than the height of the two disconnected parts 110a and the two side walls (103a, 103b) abut against the two disconnected parts 110a, the disconnected parts 110a are completely covered by the two side walls (103a, 103b) in the core sheet slot 103, thereby achieving the effect of shielding and protecting the disconnected parts 110a. In this way, the disconnected parts 110a will be completely accommodated in the core sheet slot 103 without being exposed to the air, and there is no need to worry about the problem of the oxidation on the surface of the disconnected parts 110a. It is additionally illustrated that the bottom part has two tip parts 110b which are inserted into a wire hole module 104 and into an electric wire located in the wire hole module 104.

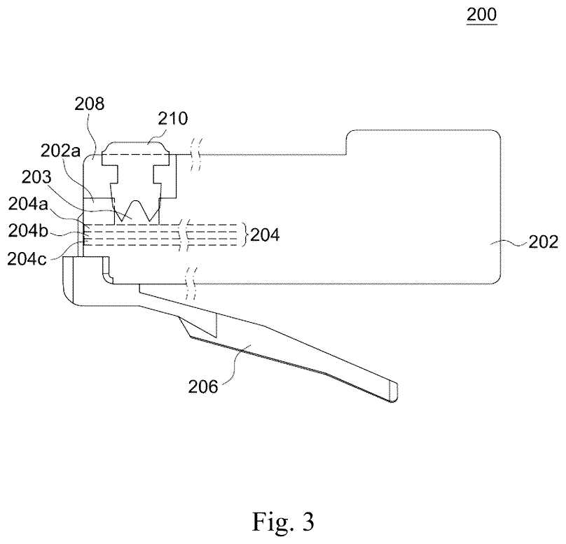

In contrast, a conventional comparative embodiment is described with reference to FIG. 3. FIG. 3 is a schematic view of a contact terminal according to a conventional comparative embodiment. As shown in FIG. 3, a contact terminal 200 comprise a core sheet 210 and a computer or telephone line connector. The computer or telephone line connector is composed of elements of a connector structure (202, 202a), a wire hole module 204, a pressing part 206, and a protective part 208. The connector structure (202, 202a) is an insulating plastic layer and is provided with a plurality of core sheet slots 203. The core sheet 210 is used to be inserted into the core sheet slot 203 until the core sheet 210 is fixed at a predetermined position in the core sheet slot 203. The wire hole module 204 comprises wire holes (204a, 204b, 204c). The bottom part of the core sheet 210 has two tip parts as the two tip parts 110b of the bottom part of the core sheet 110 in FIG. 1. It is particularly illustrated that in the comparative embodiment of the present invention in FIG. 3, the core sheet slot 203 as the connector structure 202 does not have a space for accommodating the disconnected parts of the core sheet as shown in FIG. 2.

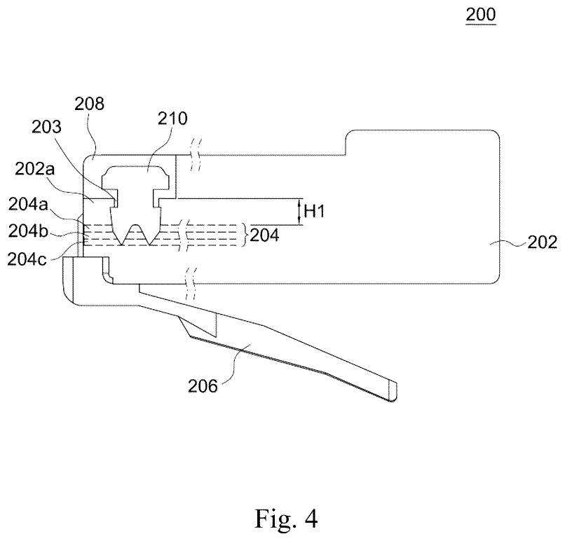

Next, a conventional comparative embodiment is described with reference to FIG. 4. FIG. 4 is a schematic view of a contact terminal according to a conventional comparative embodiment. As shown in FIG. 3, when the core sheet 210 is inserted into the core sheet slot 203 to a predetermined position, i.e. it reaches the wire hole 204c of the wire hole module 204, the connector structure 202a does not abut against the disconnected parts of the core sheet 210. It is particularly illustrated that in the conventional comparative embodiment of FIG. 4, since the core sheet slot 203 in the connector structure 202a does not have two side walls of the core sheet slot 103 as shown in FIG. 2, wherein the side walls can shield the disconnected parts of the core sheet 210, and the height of the connector structure 202a is only H1, the two disconnected parts of the core sheet 210 are exposed. In other words, the connector structure 202a cannot shield and protect the disconnected parts of the core sheet 210. The disconnected parts of the core sheet 210 is exposed without any related protective layer. Such long-term use may easily lead to oxidation and thus affects the communication and call quality.

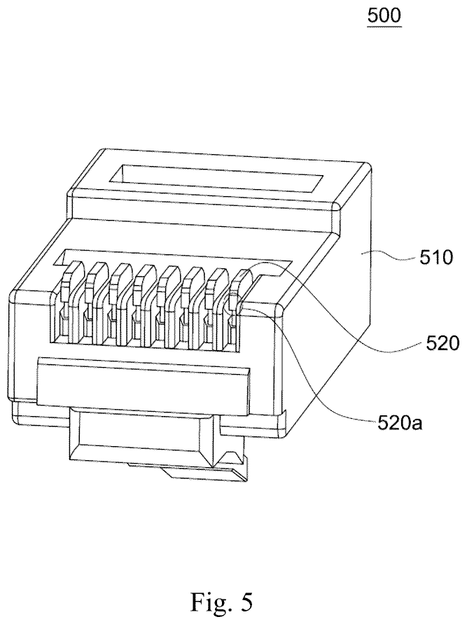

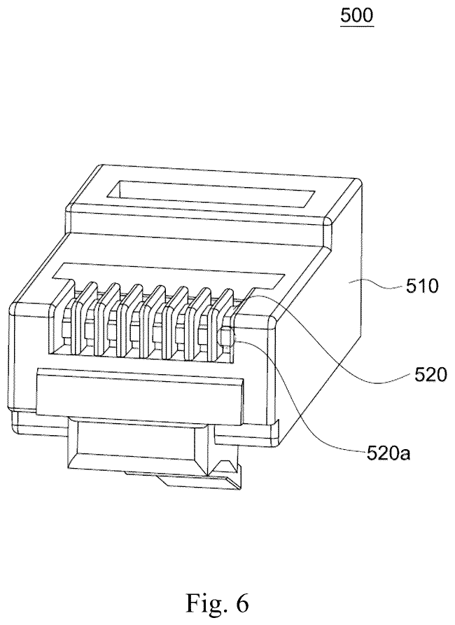

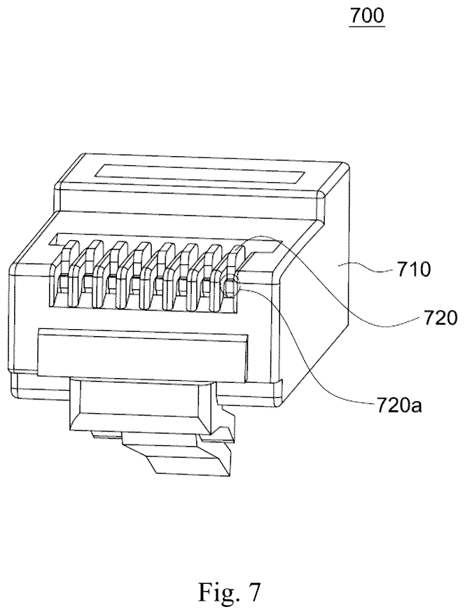

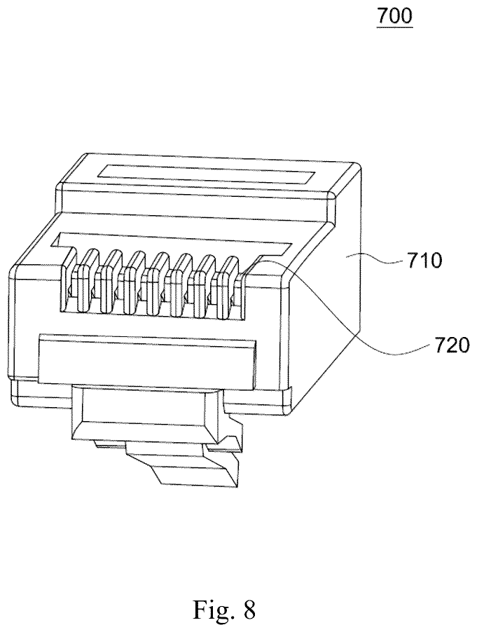

Besides, please see FIG. 5 to FIG. 8. FIG. 5 is a schematic view of a contact terminal according to a conventional comparative embodiment. FIG. 6 is a schematic view of a contact terminal according to a conventional comparative embodiment. FIG. 7 is a schematic view of a contact terminal according to another embodiment of the present invention. FIG. 8 is a schematic view of a contact terminal according to another embodiment of the present invention.

As shown in FIG. 5, in the conventional comparative embodiment of the contact terminal 500, before the processing and riveting, when the core sheets 520 are embedded into the computer or telephone line connector 510, the two disconnected parts 520a of the core sheets 520 are exposed. Next, as shown in FIG. 6, in the conventional comparative embodiment of the contact terminal 500, after the finished product is processed and riveted, when the core sheets 520 are embedded into the computer or telephone line connector 510, the two disconnected parts 520a of the core sheets 520 are still exposed.

In contrast, as shown in FIG. 7, in the contact terminal 700 of the embodiment of the present invention, before the finished product is processed and riveted, when the core sheets 720 are embedded into the computer or telephone line connector 710, the disconnected parts 720a of the core sheets 720 are exposed. However, as shown in FIG. 8, after the contact terminal 700 of the embodiment of the present invention is processed and riveted, when the core sheets 720 are inserted into the computer or telephone line connector 710, the disconnected parts 520a of the core sheets 720 are no longer exposed.

Although particular embodiments of the present invention have been described in detail for purposes of illustration, various modifications and enhancements may be made without departing from the spirit and scope of the present invention. Accordingly, the present invention is not to be limited except as by the appended claims.

1. A contact terminal, comprising:
a core sheet having two corresponding disconnected parts; and
a computer or telephone line connector having a connector structure, wherein the connector structure is provided with a plurality of core sheet slots and the core sheet slots have two corresponding side walls;
wherein two disconnected parts of the core sheet respectively abut against two side walls of the core sheet slots when the core sheet is inserted into the core sheet slots.

2. The contact terminal according to claim 1, wherein the core sheet has a top part, a neck part and a bottom part, wherein the neck part is respectively connected to the top part and the bottom part; the top part has two corresponding protrusions near the neck part; and the two protrusions respectively protrude outwards to form the disconnected parts.

3. The contact terminal according to claim 2, wherein the two side walls have a height difference and are not uniform planes, and the height of the side wall near to the front end of the contact terminal is less than the height of another side wall.

4. The contact terminal according to claim 2, wherein the heights of the two side walls are greater than the heights of the disconnected parts.

5. The contact terminal according to claim 1, wherein the contact terminal is a telephone line contact terminal or a network cable contact terminal, and the side wall near the front end of the contact terminal forms an acute angle structure at the openings of the core sheet slots.

6. The contact terminal according to claim 2, wherein the bottom part is a conductive laminate.

7. The contact terminal according to claim 6, wherein the bottom part has two tip parts which are inserted into a wire hole module of the computer or telephone line connector and into an electric wire located in the wire hole module.

8. The contact terminal according to claim 1, wherein the core sheet is inserted into the core sheet slots and the openings of the core sheet slots are higher than the top part.

9. A contact terminal, comprising:
a core sheet and
a computer or telephone line connector having a connector structure, wherein the connector structure is provided with a plurality of core sheet slots,
wherein the core sheet is inserted into the core sheet slots and two corresponding disconnected parts of the core sheet respectively abut against two corresponding side walls of the core sheet slots;
wherein the height of the side wall near the front end of the contact terminal is less than the height of another side wall.

10. The contact terminal according to claim 1, wherein the connector structure is an insulating plastic layer.

11. The contact terminal according to claim 9, wherein the connector structure is an insulating plastic layer.
